(19) United States
(12) Patent Application Publication
(10) Pub. No.: US 2015/0144110 A1
(43) Pub. Date: May 28, 2015

(54) METHOD AND CONTROL DEVICE AND DETECTION DEVICE FOR RECOGNIZING AN ENTRY OF A MOTOR VEHICLE INTO A TRAFFIC LANE OPPOSITE A DRIVING DIRECTION

(71) Applicant: Robert Bosch GmbH, Stuttgart (DE)

(72) Inventor: Holger Mielenz, Ostfildern (DE)

(21) Appl. No.: 14/553,670

(22) Filed: Nov. 25, 2014

(30) Foreign Application Priority Data
Nov. 26, 2013 (DE) 10 2013 224 171.2

(51) Int. Cl. G01N 5/02; G01H 13/00; F02M 25/08

(52) U.S. Cl. CPC G01N 5/02; F02M 25/089; G01H 13/00
USPC 123/518

(57) ABSTRACT

A device for determining the loading of a fuel vapor accumulator of an internal combustion engine includes: a vibratory mounting of the fuel vapor accumulator; and a sensor for measuring a natural frequency of the fuel vapor accumulator. For determining the loading of a fuel vapor accumulator of an internal combustion engine, a natural frequency of the fuel vapor accumulator mounted vibratorily is measured.

### BACKGROUND OF THE INVENTION

1. Field of the Invention

The present invention relates to a device and method for determining the loading of a fuel vapor accumulator of an internal combustion engine.

2. Description of the Related Art

Internal combustion engines, in particular internal combustion engines for motor vehicles, are equipped with a so-called fuel vapor recirculation system to prevent fuel evaporating from the fuel tank from getting into the environment. To this end, so-called fuel vapor accumulators are provided which, for example, may be implemented as activated carbon filters. These fuel vapor accumulators absorb fuel vapor evaporating in the tank. These filters are regenerated by air purging. The purge air flows through the activated carbon filter where it captures fuel and is fed to the internal combustion engine as fuel-loaded regeneration gas. The activated carbon filter is regenerated by air purging, for example, by opening a canister purge valve between the activated carbon filter and the intake manifold of the internal combustion engine. In this case, the filter is purged by the intake manifold underpressure via a fresh air valve. The fuel-loaded regeneration gas flows to the internal combustion engine via the canister purge valve, in this case following the pressure gradient. To prevent the internal combustion engine's emissions performance from being adversely affected during such a purge process, the degree of loading of the fuel vapor accumulator must be known. As a function of this degree of loading, the quantity of fuel injected into the internal combustion engine's combustion chambers is varied.

In methods known from the related art, the quantity of fuel taken in by the fuel vapor accumulator is calculated using the measured air ratio λ (lambda) and regulated to a setpoint value. Since the degassing characteristics of the fuel in the tank, which depend on the fuel characteristics, the ambient temperature, the ambient pressure and other factors, is generally unknown, the volume of fuel stored in the fuel vapor accumulator is also unknown.

To determine the need for tank venting phases as precisely as possible and to be able to adjust the pilot control of the injection correction in an ideal manner, the volume of hydrocarbon adsorbed in the fuel vapor accumulator, i.e., the so-called loading, must be known.

The loading of the fuel vapor accumulator is determined in the methods known from the related art, for example, due to direct measurement of the hydrocarbon concentration based on the purge quantity, as known, for example from published German patent application document DE 101 26 520 A1, or by measurement of the temperature in the fuel vapor accumulator designed as an activated carbon filter.

Published German patent application document DE 10 2006 027 572 A1 describes measuring the adsorbed volume of hydrocarbon by determining the weight of the fuel vapor accumulator and by comparing it with the previously determined weight of the emptied fuel vapor accumulator.

### BRIEF SUMMARY OF THE INVENTION

Despite the advantages resulting from the described devices and methods for determining the loading condition of a fuel vapor accumulator, they still have potential for improvement. Thus, the above-described measuring methods for measuring the loading are relatively imprecise or comparatively complex in their design and consequently expensive to implement.

One objective of the present invention is thus to at least largely avoid the above-described disadvantages and provide a device and a method for determining the loading of a fuel vapor accumulator of an internal combustion engine, making it possible to measure the loading very rapidly, at high precision and cost-effectively.

A device according to the present invention for determining the loading of a fuel vapor accumulator of an internal combustion engine has a vibratory mounting of the fuel vapor accumulator and a sensor for measuring a natural frequency of the fuel vapor accumulator.

The sensor may be an acceleration sensor. In the context of the present invention, an acceleration sensor may be understood to be a sensor which is suitable for measuring the force exerted on an inert mass by an acceleration. Both path-measuring systems and systems that measure mechanical stress may be used. Examples of such acceleration sensors and their measuring principles are described, for example, in Konrad Reif (Editor): Sensoren im Kraftfahrzeug [Motor Vehicle Sensors], 1st edition 2010, pp 75-79, which are incorporated herein by reference. The sensors described there are basically usable in the context of the present invention.

In the context of the present invention, a natural frequency of a component should be understood to be a frequency of a vibratory component, at which the component may vibrate as a normal mode after a one-time excitation.

The device may be designed to carry out the determination of the loading due to changes of the natural frequency of the fuel vapor accumulator. The device may be designed for carrying out the determination in a fuel vapor accumulator excited to vibrate. The device maybe designed to carry out the determination by comparing the natural frequency in an at least partially loaded fuel vapor accumulator with the natural frequency in an unloaded fuel vapor accumulator. An at least partially loaded fuel vapor accumulator may be determinable by a lower natural frequency than an unloaded fuel vapor accumulator. For the determination, the natural frequency in an unloaded fuel vapor accumulator and the natural frequency in a completely loaded fuel vapor accumulator may be usable as reference values.

In the case of a method for determining the loading of a fuel vapor accumulator of an internal combustion engine, the fuel vapor accumulator is mounted vibratorily and a natural frequency of the fuel vapor accumulator is measured.

A sensor may be used for measuring the natural frequency of the fuel vapor accumulator. The sensor may be, for example, an acceleration sensor. The loading may be inferred due to changes of the natural frequency of the fuel vapor accumulator. In this case, the determination may be carried out in a fuel vapor accumulator excited to vibrate. The determination may be carried out by comparing a natural frequency in an at least partially loaded fuel vapor accumulator with a natural frequency in an unloaded fuel vapor accumulator. An at least partially loaded fuel vapor accumulator may be determined by a lower natural frequency than an unloaded fuel vapor accumulator. For the determination, a natural frequency in an unloaded fuel vapor accumulator and a natural frequency in a completely loaded fuel vapor accumulator may be used as reference values.

A basic idea of the present invention is to measure the natural frequency of the fuel vapor accumulator with the aid of an economically priced acceleration sensor. A requirement for this is an elastically suspended fuel vapor accumulator, i.e., a fuel vapor accumulator mounted vibratorily. During operation of the motor vehicle, shaking movements at the natural frequency of the system are to be expected and this natural frequency is ascertained with the aid of the acceleration sensor. A change in mass due to the loading of the activated carbon filter causes this natural frequency to be shifted to lower frequencies. For that reason, the loading condition may be inferred by measuring the natural frequency during vehicle operation.

Accordingly, the fuel vapor accumulator is to be suspended elastically or mounted vibratorily and provided with an acceleration sensor. The natural frequency of the fuel vapor accumulator is subsequently determined with an empty and full activated carbon canister for the particular application of the system. During operation of the motor vehicle, the loading condition is measured by continuous measurement of the vibrations triggered by the vehicle operation with the aid, for example, of a Fourier analysis of the signal of the acceleration sensor. The loading condition may, for example, be determined by comparing the previously measured natural frequencies with the natural frequencies measured during vehicle operation. The present invention is usable in particular in vehicles having gasoline engines including a tank venting system.

### BRIEF DESCRIPTION OF THE DRAWING

FIG. 1 shows a schematic representation of a device according to the present invention for determining the loading of a fuel vapor accumulator of an internal combustion engine.

### DETAILED DESCRIPTION OF THE INVENTION

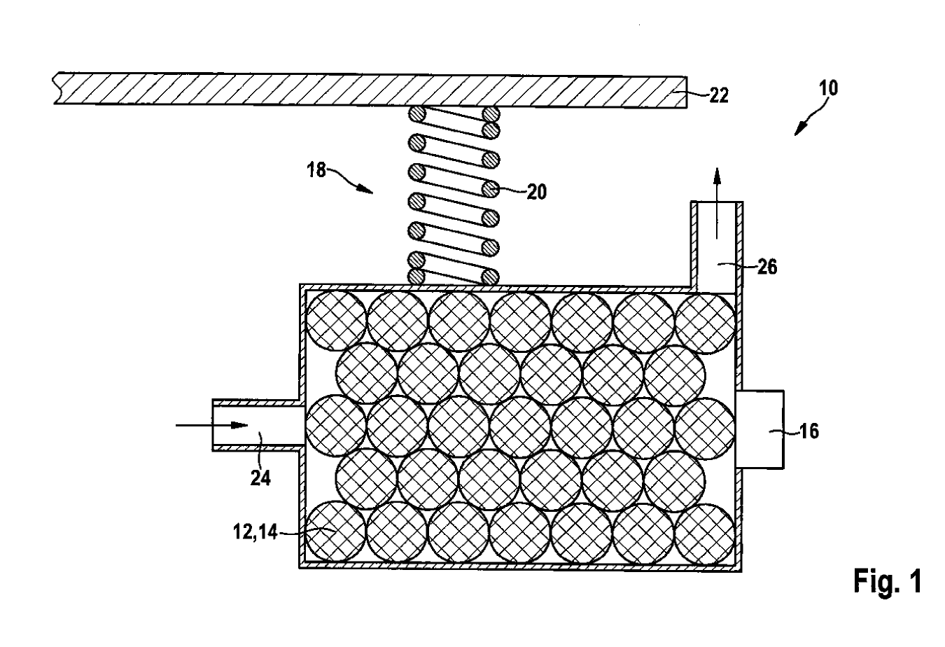

FIG. 1 shows a schematic representation of a device 10 according to the present invention for determining the loading of a fuel vapor accumulator 12 of an internal combustion engine, which is not shown in greater detail. Fuel vapor accumulator 12 may, for example, be designed as an activated carbon filter 14. An acceleration sensor 16 is attached to fuel vapor accumulator 12. Fuel vapor accumulator 12 is mounted vibratorily. For example, fuel vapor accumulator 12 is mounted in vibratory suspension or mounting 18. This mounting 18 may, for example, be implemented, as shown schematically in FIG. 1, using a spring 20 on a body component 22. It is understood that the number of springs 20 is not limited to one spring 20, but instead multiple springs 20 maybe used. However, connecting rubber hoses or other components suitable for a vibratory mounting may also be provided instead of springs 20. Furthermore, instead of a vibratory suspension, purely as a matter of principle, it could also be provided to mount fuel vapor accumulator 12 resting on spring elements 20. In this case, it must be ensured that the mounting has the properties of a spring or is excitable to vibrate.

Device 10 may be part of a fuel supply system of an internal combustion engine and be provided in particular for use in a motor vehicle. The internal combustion engine may, for example, be in particular a gasoline engine of a motor vehicle. Fuel vapors escape from the fuel container, for example, a tank. For example, unwanted pressure builds up when the tank is heated. This overpressure is reduced via a venting system. To prevent the escape of hydrocarbons into the environment, a fuel vapor accumulator 12 is provided on the ventilation system. Thus, for example, the fuel vapors pass via a connector 24 from the tank into fuel vapor accumulator 12 and via an outlet 26 into the environment.

As mentioned, the tank venting system is provided to prevent the escape of fuel vapors from the tank into the environment. For this purpose, fuel vapor accumulator 12 is provided in the form of activated carbon filter 14. A shutoff valve, which is not shown in greater detail, may be provided in the ventilation line of fuel vapor accumulator 12. Furthermore, a canister purge valve may be provided between fuel vapor accumulator 12 and the intake manifold of the internal combustion engine. Fuel evaporating in the tank is stored in activated carbon filter 14 and supplied for combustion via the open canister purge valve during the operation of the internal combustion engine. Due to the pressure ratios occurring, activated carbon filter 14 is simultaneously purged with fresh air and consequently regenerated while the shutoff valve is open.

A control unit, which is not shown in greater detail, may be used for controlling the tank ventilation by opening and closing the above-named valves. As will be described in greater detail below, signals of acceleration sensor 16, which measures the natural frequency of the activated carbon filter excited to vibrate, are fed to the control unit. Furthermore, signals characterizing the operating condition of the internal combustion engine and signals characterizing the fuel/air mixture are fed to the control unit.

During the regeneration of activated carbon filter 14, hydrocarbon vapors enter the intake manifold of the internal combustion engine in the manner described above and are taken in by it together with the fresh air. So that the correct quantity of fuel is available in the internal combustion engine, the control unit reduces the injection quantity and activates the fuel metering means accordingly. To be able to determine the need for tank venting phases as precisely as possible and to be able to adjust the pilot control and injection correction optimally, the volume of absorbed hydrocarbons, i.e., the loading, must be determined.

The determination of the loading of activated carbon filter 14, i.e., the determination of the volume of the hydrocarbon compound adsorbed in activated carbon filter 14, may now be carried out as follows. Activated carbon filter 14 is mounted vibratorily, for example, with the aid of above-described vibratory mounting 18. An acceleration sensor 16 is connected to activated carbon filter 14. Acceleration sensor 16 measures a natural frequency of activated carbon filter 14 in an unloaded condition and in a completely loaded condition. These measured values, i.e., the value of the natural frequency in unloaded activated carbon filter 14 and the value in completely loaded activated carbon filter 14, are used as reference values. During an operation of the motor vehicle, shaking movements at the natural frequency of activated carbon filter 14 are to be expected. This natural frequency is ascertained with the aid of acceleration sensor 16 during the ongoing operation of the motor vehicle. A changed mass due to the loading of the activated carbon filter 14 causes this natural frequency to be shifted to lower frequencies. Accordingly, the loading may be carried out due to changes in the natural frequency of fuel vapor accumulator 12. In particular, the determination may be carried out in activated carbon filter 14 which is excited to vibrate. In this process, the above-described comparison of the measurement of the natural frequency in an at least partially loaded fuel vapor accumulator with the natural frequency in an unloaded fuel vapor accumulator, i.e., the reference value in an unloaded activated carbon filter 14, the loading condition is inferred. An at least partially loaded fuel vapor accumulator 12 may be determined by a lower natural frequency than an unloaded activated carbon filter 14. The natural frequencies in an unloaded activated carbon filter 14 and in a completely loaded activated carbon filter 14 are used as reference values, and partially loaded conditions of activated carbon filter 14 may be ascertained by, for example, interpolating the reference values.

What is claimed is:

1. A device for determining the loading of a fuel vapor accumulator of an internal combustion engine, comprising:
a vibratory mounting of the fuel vapor accumulator; and
a sensor for measuring a natural frequency of the fuel vapor accumulator.

2. The device as recited in claim 1, wherein the sensor is an acceleration sensor.

3. The device as recited in claim 2, wherein the device is configured to determine the loading in the fuel vapor accumulator which is excited to vibrate.

4. The device as recited in claim 3, wherein an at least partial loading of the fuel vapor accumulator is determined if a measured natural frequency is lower than a natural frequency of an unloaded fuel vapor accumulator.

5. The device as recited in claim 4, wherein a natural frequency of an unloaded fuel vapor accumulator and a natural frequency of a completely loaded fuel vapor accumulator are used as reference values for the determination of the loading.

6. A method for determining the loading of a fuel vapor accumulator of an internal combustion engine, comprising:
mounting the fuel vapor accumulator vibratorily; and
measuring a natural frequency of the fuel vapor accumulator.

7. The method as recited in claim 6, wherein the loading is inferred from changes of the natural frequency of the fuel vapor accumulator.

8. The method as recited in claim 6, wherein the determination is carried out by comparing a natural frequency in an at least partially loaded fuel vapor accumulator with a natural frequency in an unloaded fuel vapor accumulator.

9. The method as recited in claim 6, wherein an at least partial loading of the fuel vapor accumulator is determined if a measured natural frequency is lower than a natural frequency of an unloaded fuel vapor accumulator.

10. The method as recited in claim 6, wherein a natural frequency of an unloaded fuel vapor accumulator and a natural frequency of a completely loaded fuel vapor accumulator are used as reference values for the determination of the loading.
